(19) United States
(12) Patent Application Publication
(10) Pub. No.: US 2011/0122409 A1
(43) Pub. Date: May 26, 2011

(54) OBJECT CHARACTERISTIC MEASUREMENT METHOD AND SYSTEM

(75) Inventors: YI-CHEN HSIEH, Changhua County (TW); Fu-Shiang Yang, Hsinchu County (TW)

(73) Assignee: Industrial Technology Research Institute, Hsinchu (TW)

(21) Appl. No.: 12/713,352

(22) Filed: Feb. 26, 2010

(30) Foreign Application Priority Data
Nov. 20, 2009 (TW) 098139634

(51) Int. Cl. G01N 21/21

(52) U.S. Cl. 356/365

(57) ABSTRACT

The present invention provides a method for measuring object characteristics, wherein the method is capable of overcoming the interference induced bye the phase difference of the background with respect to the measuring system so as to measure the tiny characteristics such as the retardance or azimuth angle of an object accurately. The method is capable of obtaining two sets of light intensity images having retardance of background and the object respectively by simultaneously rotating the retarding elements and analyzer in various rotating angle combinations, and analyzing and calculating upon the polarized light intensities of the images associated with the background and the object so as to obtain actual retardance and azimuth angle of the object without the affect of the background retardance.

### TECHNICAL FIELD

The present disclosure relates to an object characteristic measurement method and system, and more particularly, to a low retrarance/azimuth angle measurement method and system.

### TECHNICAL BACKGROUND

With rapid advance of LCD industry, the LCD panels being manufactured are becoming larger and larger. However, during the manufacturing of such large-sized LCD panels, the possibility of cracks being introduced to the substrates of such LCD panels, such as glass substrates or flexible substrates, are great that is going to cause serious adverse affect upon the yield of the LCD panel production. It is noted that there can be a variety of stresses resided in a substrate that are caused from the various procedures applied on the substrate in the LCD manufacturing process. For instance, the thermal stress resulting from the temperature variation during the repetitive film deposition procedures; or the mechanical stress resulting from a cutting/abrasive procedure at a position where it is being cut. Accordingly, since there are already those many stresses resided in the substrate, any external force, only as slightly as possible, during the transportation of the substrate is going to crack the substrate and any micro crack on the substrate is more than likely to propagate which might eventually cause the substrate to break.

For preventing the cracking of the substrate and thus improving the production yield, a manufacture procedure is required for measuring the residue stress of the substrate in real time. If the distribution and the magnitude of stresses resided in a substrate can be monitored and measured as it is being processed in a manufacturing process, the area on the substrate where it is more than likely to crack can be specified in advance and not can be can be deal with in real time, but also can be provided as a reference for future improvement. Thus, in any manufacturing process, it is important to be able to detect defects, or micro cracks on a substrate and also the accumulation of stress in the substrate as soon as possible. However, since the defects and cracks on a substrate as well as the stresses in the substrate can be vary small when they are first being caused, the resolutions of the conventional techniques such as photo-elasticity and phase analysis are not precise enough for a user to identify those defects and cracks on a substrate as well as the stresses in the substrate the minute when they are first being caused so as to take a remedial action.

There are already many studies trying to detect the generation of defects and cracks on a substrate as well as the accumulation of stresses in the substrate in real time. One of which is a system for measuring material properties of samples, disclosed in U.S. Pat. No. 6,501,458, entitled “Retardance measurement method”. As shown in FIG. 1, the optical microscope system in characterized in that there are two variable retarders, i.e. a first retarder and a second retarder, being fixedly located in the illumination path between a linear polarized and a condenser lens, whereas on the illumination side of the condenser lens, there are an interference filter, the linear polarizer, and the pair of variable retarders; and on the imaging side of the sample stage and objective lens, i.e., between the objective lens and the video camera 16, there is a left circular analyzer. Moreover, the linear polarizer and the two retarders on the illumination side forms an elliptical polarizer, which are used to generate five different elliptical polarized beams by adjusting the retardances of the two retarders in respective. In addition, in the imaging side, through the circular analyzer, the camera is enabled to capture images of the sample that record the apparent retardances of the same under different polarization conditions and in the presence of spurious background retardance contributed by the optical components in the microscope system. By analyzing the ten images obtained by the camera resulting from the five different elliptical polarized beams, accurate sample retardance and azimuth value can be obtained without being contaminated by the background retardance.

### TECHNICAL SUMMARY

In an exemplary embodiment of the present disclosure, a low retardance measurement method is provided, which comprises the steps of: providing a polarized light while enabling the same to pass sequentially through a first retarder, a second retarder and an analyzer; enabling the fast axis of the first retarder and the slow axis of the second retarder to turn in synchronization to a first angle and a second angle so as to respectively capture a plurality of first optical characteristic values relating to the analyzer at different polarization angles in correspondence to the first and the second angle; placing an object at a position between the first retarder and the second retarder; enabling the fast axis of the first retarder and the slow axis of the second retarder to turn in synchronization to the first angle and the second angle so as to respectively capture a plurality of second optical characteristic values relating to the analyzer at different polarization angles in correspondence to the first and the second angle; and performing a calibration analysis of background retardance compensation according to the first optical characteristic values and the second optical characteristic values so as to obtain a retardance relating to the object.

In another exemplary embodiment of the present disclosure, an object characteristic measurement system is provided, which comprises: a linear polarization module, for providing a linear polarized light; a retarding element, including a first retarder and a second retarding, both being disposed at a side of the liner polarization module for receiving the linear polarized light while capable of being respectively driving to rotate in synchronization by a first driving force, being configured in a manner that the first retarder is arranged between the second retarder and the liner polarization module while forming a space between the first retarder and the second retarder to be used for receiving an object; a linear analyzer, disposed at a side of the second retarder while capable of being driven to rotate by a second driving force; an imaging unit, for capturing an image of intensity resulting from the linear polarized light after it had sequentially traveled passing the first retarder, the second retarder, the object, and the linear analyzer; and a calculation unit, for performing a calculation for obtaining a property of the object, basing upon the following data sets: a plurality of angular arrangements relating to the angles of the first retarder, the second retarder and the linear analyzer in combination, images obtained from the imaging unit that are captured while the object is not existed in the space, and images obtained from the imaging unit that are captured while the object is existed in the space.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a low retardance measurement system disclosed in U.S. Pat. No. 6,501,548.

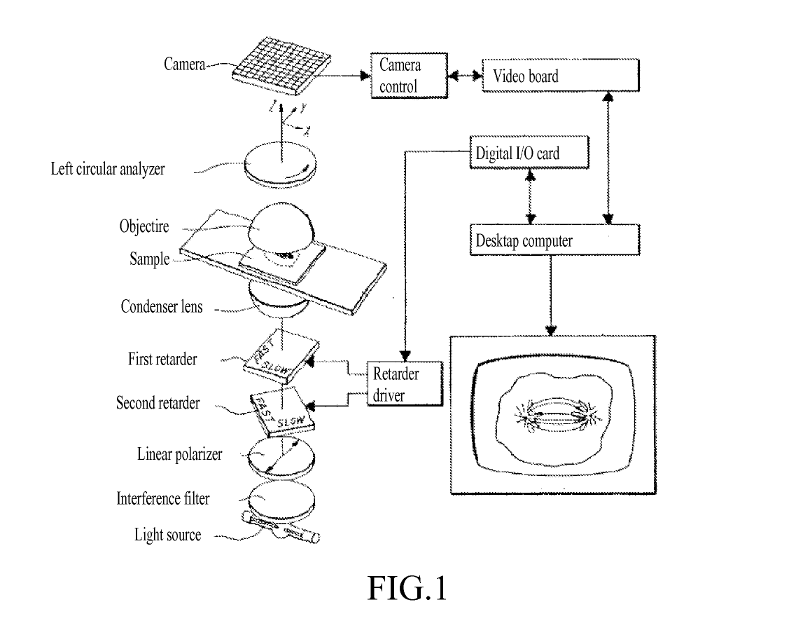

FIG. 2 is a flow chart depicting steps of an object characteristic measurement method according to an embodiment of the present disclosure.

FIG. 3 is a schematic diagram showing an object characteristic measurement system according to an embodiment of the present disclosure.

FIG. 4 is a flow chart depicting steps of a retardance correction procedure used in an object characteristic measurement method of the present disclosure.

FIG. 5 is a flow chart depicting steps of an azimuth angle correction procedure used in an object characteristic measurement method of the present disclosure.

FIG. 6 is a profile of an arctangent function.

FIG. 7 is a flow chart depicting steps for processing arctangent function according to the present disclosure.

FIG. 8 is a schematic diagram showing how an angular area is being divided in the present disclosure.

FIG. 9 is a schematic diagram showing an object characteristic measurement system according to another embodiment of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

The present disclosure provides an object characteristic measurement method, which is able to obtain a highly sensitive measurement relating to retardance magnitude and angular orientation values at all points in a large two-dimensional scene without the help of any specialized optical elements, and thus it is not restricted by those hard-to-get variable retarders, such as the liquid crystal variable retarders, as those conventional retardance measurement techniques did.

Furthermore, the object characteristic measurement method of the resent disclosure overcome the interference of so-call background retardance contributed by other components than the measured object so as to determine the property of the measured object, such as the retardance and azimuth angle. It is noted that the measurement method of the present disclosure is able to generate a data set of measured object retardance while representing the same as a two-dimensional image by the help of an imaging system, by that the measurement method of the present disclosure can be adapted for measuring materials properties, such as strain, thickness and defects in the two-dimensional image.

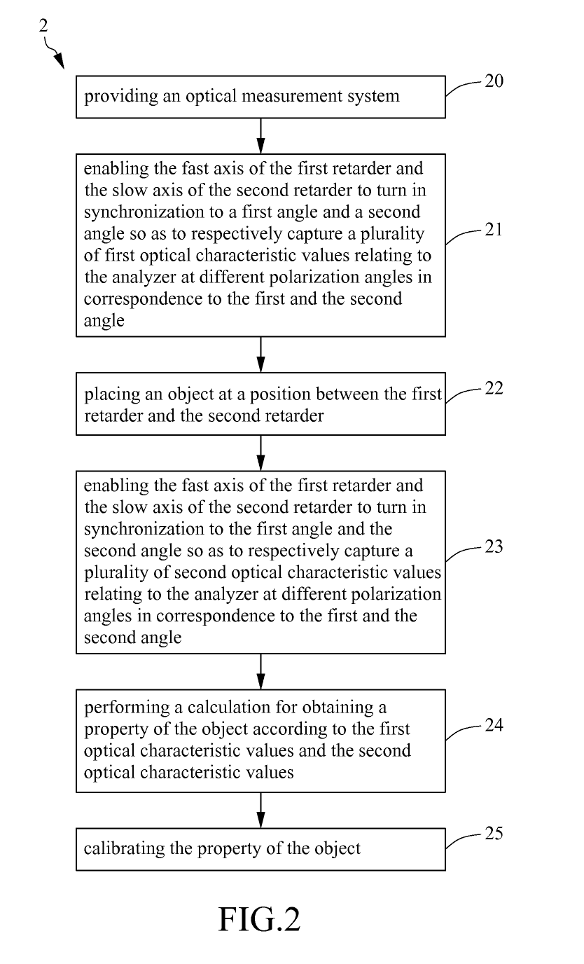

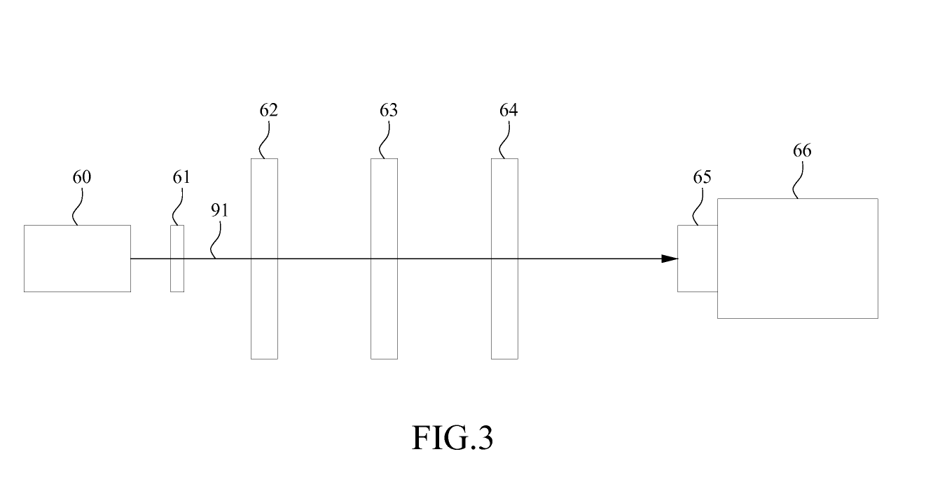

Please refer to FIG. 2, which is a flow chart depicting steps of an object characteristic measurement method according to an embodiment of the present disclosure. The aforesaid method 2 starts from step 20. At step 20, an optical measurement system 6 is provided, as shown in FIG. 3, which comprises: a light source 60, for providing a collimated light of single wavelength λ; and a linear polarizer 61, for polarizing the collimated light into a linear polarized light 91; and then the flow proceeds to step 21. In this embodiment, there are a first retarder 62, a second retarder 63, and an analyzer 64 disposed at a side of the linear polarizer 61 in series at position between the linear polarizer 61 and an imaging unit, whereas the imaging unit is composed of a display element 65 and an image capturing element 66. It is noted that the first and the second retarder 62, 63 are quarter-wave plates and the analyzer 61 is a linear polarizer. Moreover, the fast axis of the first retarder 62 orientated 90 degrees apart from the fast axis of the second retarder 63.

At step 21, a process is perform for enabling the fast axis of the first retarder 62 and the slow axis of the second retarder 63 to turn in synchronization to a first angle and a second angle so as to respectively capture a plurality of first optical characteristic values relating to the analyzer 64 at different polarization angles in correspondence to the first and the second angle; and then the flow proceeds to step 22. In this embodiment, the first optical characteristic can be light intensity, and the performing of the step 21 is for acquiring images while there is no object to be tested being placed in the optical measurement system 6, so that each images obtained at step 21 contains so-called background retardance contributed only by the components of the optical measurement system 6.

During the performing of the step 21, there can be a plurality of images being taken by orientating the first retarder 62, the second retarder 63 and the analyzer 64 at different first angles, second angles and polarization angles. In this embodiment, there can be six different groupings of the first angles, second angles and polarization angle for defining the orientation of the first retarder 62, the second retarder 63 and the analyzer 64, that are used for taking six images without the tested object. The aforesaid six groupings are shown in the following Table 1:

| grouping | First retarder | Second retarder | analyzer |
|---|---|---|---|
| 1 | 45° | 45° | 90° |
| 2 | 45° | 45° | 0° |
| 3 | 90° | 90° | 135° |
| 4 | 45° | 45° | 45° |
| 5 | 90° | 90° | 45° |
| 6 | 45° | 45° | 135° |

Accordingly, when the linear polarized light 91 from the light source 60 is projected on the display element 65 after traveling passing through the first retarder 62, the second retarder 63 and the analyzer 64, the image capturing element 66 will capture six different images of background retardance from the display element 65 in corresponding to the six groupings. It is noted that the numbering of the groupings shown in Table 1 is not used for specifying their orders, that the six images can be taken randomly without being limited by the numbering of the grouping, only if they are taken when the first retarder, the second retarder and the analyzer are orientated at angles specified in the groupings.

At step 22, an object to be measured is placed at a position between the first retarder 62 and the second retarder 63; and then the flow proceeds to step 23. At step 23, similarly, a process is performed for enabling the fast axis of the first retarder 62 and the slow axis of the second retarder 63 to turn in synchronization to a first angle and a second angle so as to respectively capture a plurality of first optical characteristic values relating to the analyzer 64 at different polarization angles in correspondence to the first and the second angle; and then the flow proceeds to step 24. Basically, the process performed in step 23 is similar to that of step 21 in that: there are the same six groupings, as shown in Table 1, that are used for taking six images, is different in that: the images taken in step 24 is influenced by the presence of the tested object. Accordingly, when the linear polarized light 91 from the light source 60 is projected on the display element 65 after traveling passing through the first retarder 62, the second retarder 63 and the analyzer 64, the image capturing element 66 will capture six different images influenced by the presence of the tested object from the display element 65 in corresponding to the six groupings. Similarly, the numbering of the groupings shown in Table 1 is not used for specifying their orders, that the six images can be taken randomly without being limited by the numbering of the grouping, only if they are taken when the first retarder, the second retarder and the analyzer are orientated at angles specified in the groupings

After obtaining six images of background retardance and six images influenced by the presence of the tested object, the step 24 is performed. At step 24, a calculation is performed for obtaining a property of the object according to the first optical characteristic values and the second optical characteristic values; and the flow proceeds to step 25. In this embodiment, the property of the object can be the retardance or the azimuth angle of the object. The following description will illustrate the proceedings for measuring retardance of the object. When the method 2 of the present disclosure is adapted for measuring retardance of the object, the calculation in step 24 is performed according to the following equation:

$$δ = {tan}^{- 1} [ \sqrt{\begin{matrix}{( \frac{{I}_{5} - {I}_{3}}{{I}_{1} - {I}_{2}} - \frac{{B}_{5} - {B}_{3}}{{B}_{1} - {B}_{2}} )}^{2} + \\ {( \frac{{I}_{4} - {I}_{6}}{{I}_{1} - {I}_{2}} - \frac{{B}_{4} - {B}_{6}}{{B}_{1} - {B}_{2}} )}^{2}\end{matrix}} ] \qquad ( 1 )$$

wherein, δ is the raw retardance;
B₁˜B₆ are the intensities of the six images of background retardance that are taken at step 21;
I₁˜I₆ are the intensities of the six images influenced by the presence of the tested object, that are taken at step 24.
   However, the retardance obtained from equation (1), referred as the raw retardance hereinafter, is not ranged between 0 degree and 180 degrees. Thus, in order to enable the effective area of the raw retardance from equation (1) to be ranged between 0 degree and 180 degrees, a correction procedure for calibrating the property of the object is required, as the one shown in step 25. At step 25, a correction procedure is performed for calibrating the raw retardance so as to obtain an accurate retardance resulting only by the object.

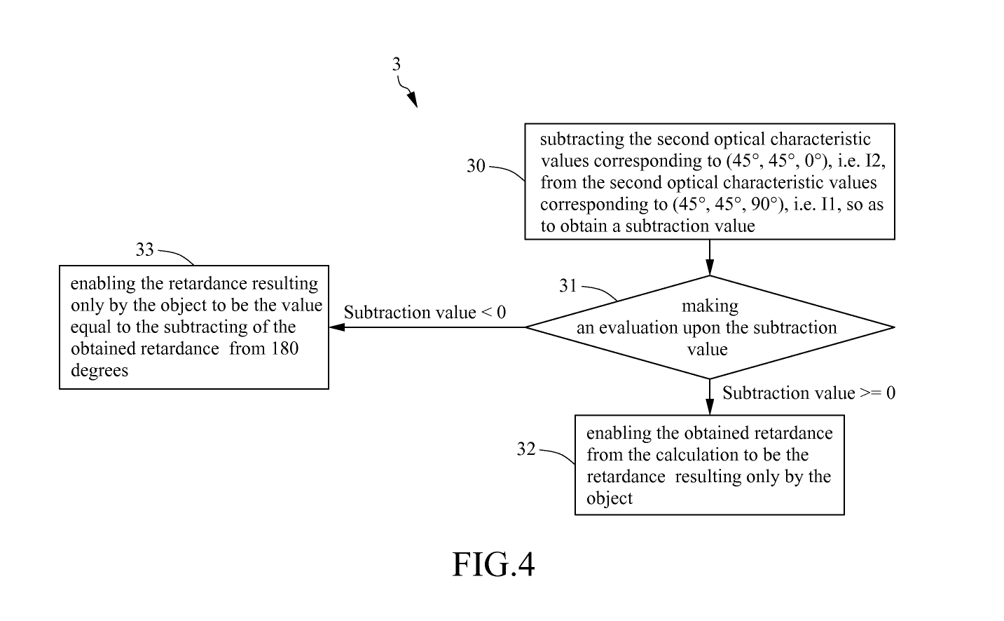

Please refer to FIG. 4, which is a flow chart depicting steps of a retardance correction procedure used in an object characteristic measurement method of the present disclosure. The retardance correction procedure 3 of FIG. 4 starts from step 30. At step 30, a process is performed for subtracting the second optical characteristic values corresponding to (45°, 45°, 0°), i.e. I₂, from the second optical characteristic values corresponding to (45°, 45°, 90°), i.e. I₁, so as to obtain a subtraction value; and then the flow proceeds to step 31. Please refer to the following Table 2, which shows the mathematic relationships relating to the optical characteristic values obtained from the previously captured images, as following:

| numbering | intensity | Mathematic relations |
|---|---|---|
| 1 | I₁ | I₁ = I_{b} + Iₘ cos δₐ |
| 2 | I₂ | I₂ = I_{b} − Iₘ cos δₐ |
| 3 | I₃ | I₃ = I_{b} − Iₘ sin δₐ sin 2φₐ |
| 4 | I₄ | I₄ = I_{b} + Iₘ sin δₐ cos 2φₐ |
| 5 | I₅ | I₅ = I_{b} + Iₘ sin δₐ sin 2φₐ |
| 6 | I₆ | I₆ = I_{b} − Iₘ sin δₐ cos 2φₐ |

wherein, δₐ represents the retardance; and
φₐ represents the azimuth angle.

According to the aforesaid Table 2, the subtraction of step 30, i.e., I₁−I₂, is equal to 2Iₘ cos δₐ. Thus, the subtraction I₁−I₂ is substantially a cosine function of δₐ, which can be used in the evaluation perform in step 31. At step 31, when the subtraction is lager than or equal to zero, the obtained retardance δᵣ from the calculation is ranged between 0 degree and 90 degrees, and thus the flow is directed to proceed with the step 32 for enabling the obtained retardance δᵣ from the calculation to be the retardance δ resulting only by the object. On the other hand, when the subtraction is smaller than zero, the obtained retardance δᵣ from the calculation is ranged between 90 degrees and 180 degrees, and thus the flow is directed to step 33 for enabling the retardance δ resulting only by the object to be the value equal to the subtracting of the obtained retardance δᵣ from 180 degrees.

The following description will illustrate the proceedings for measuring azimuth angle of the object. When the method 2 of the present disclosure is adapted for measuring azimuth angle φ of the object, the calculation in step 24 is performed according to the following equation:

$$φ = \frac{1}{2} {tan}^{- 1} [ \frac{\frac{{I}_{5} - {I}_{3}}{{I}_{1} - {I}_{2}} - \frac{{B}_{5} - {B}_{3}}{{B}_{1} - {B}_{2}}}{\frac{{I}_{4} - {I}_{6}}{{I}_{1} - {I}_{2}} - \frac{{B}_{4} - {B}_{6}}{{B}_{1} - {B}_{2}}} ] \qquad ( 2 )$$

However, the azimuth angle obtained from equation (2), referred as the raw azimuth angle hereinafter, is not ranged between 0 degree and 180 degrees. Thus, in order to enable the effective area of the raw azimuth angle e from equation (2) to be ranged between 0 degree and 180 degrees, a correction procedure for calibrating the property of the object is required, as the one shown in step 25. At step 25, a correction procedure is performed for calibrating the raw azimuth angle so as to obtain an accurate azimuth angle resulting only by the object.

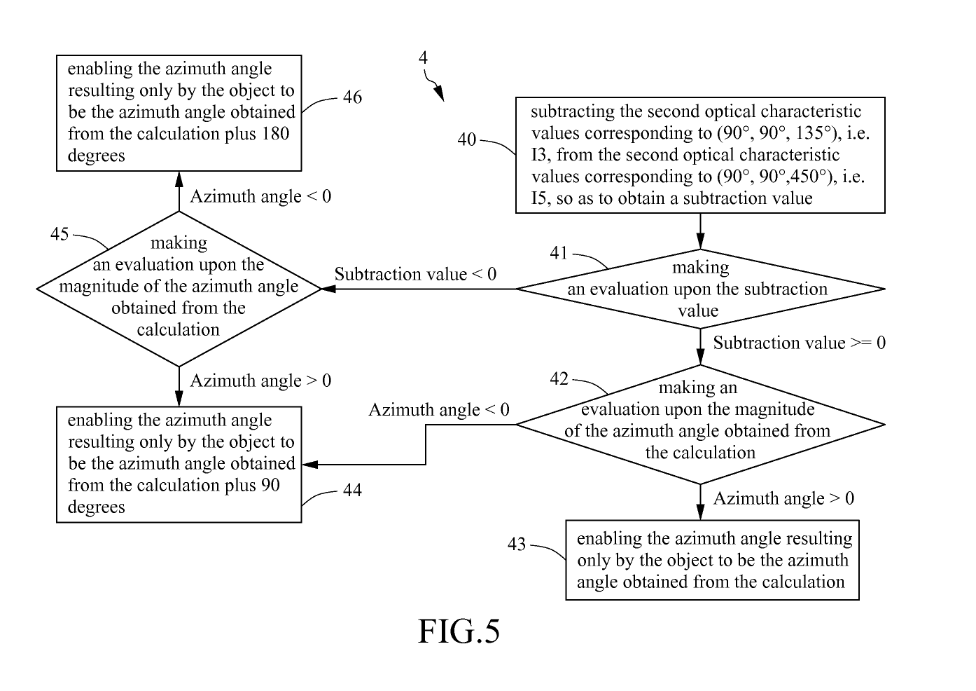

Please refer to FIG. 5, which is a flow chart depicting steps of an azimuth angle correction procedure used in an object characteristic measurement method of the present disclosure. The azimuth angle correction procedure 4 of FIG. 5 starts from step 40. At step 40, a process is performed for subtracting the second optical characteristic values corresponding to (90°, 90°, 135°), i.e. I₃, from the second optical characteristic values corresponding to (90°, 90°, 450°), i.e. I₅, so as to obtain a subtraction value, which is equal to 2Iₘ sin δₐ sin 2φₐ according to Table 2; and then the flow proceeds to step 41. At step 41, an evaluation relating to the subtraction value is made; and if the subtraction value is larger than or equal to zero, the flow proceeds to step 42; otherwise, the flow is directed to step 45. At step 42, an evaluation relating to the magnitude of the raw azimuth angle obtained from the calculation is made; and if the raw azimuth angle is larger than zero, the flow will proceed to step 43 for enabling the azimuth angle resulting only by the object to be the raw azimuth angle obtained from the calculation; otherwise, the flow will be directed to step 44 for enabling the azimuth angle resulting only by the object to be the raw azimuth angle obtained from the calculation plus 90 degrees. As in step 41, the flow will be directed to step 45 when the subtraction value is smaller zero. At step 45, another evaluation relating to the magnitude of the raw azimuth angle obtained from the calculation is made; and if the raw azimuth angle is larger than zero, the flow will proceed to step 44 for enabling the azimuth angle resulting only by the object to be the raw azimuth angle obtained from the calculation plus 90 degrees; otherwise, the flow will be directed to step 46 for enabling the azimuth angle resulting only by the object to be the azimuth angle obtained from the calculation plus 180 degrees.

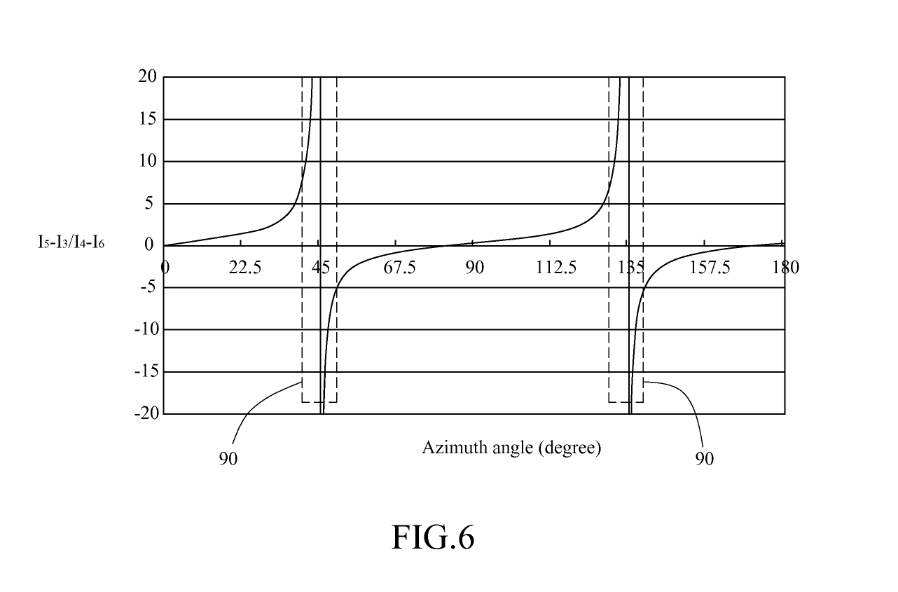

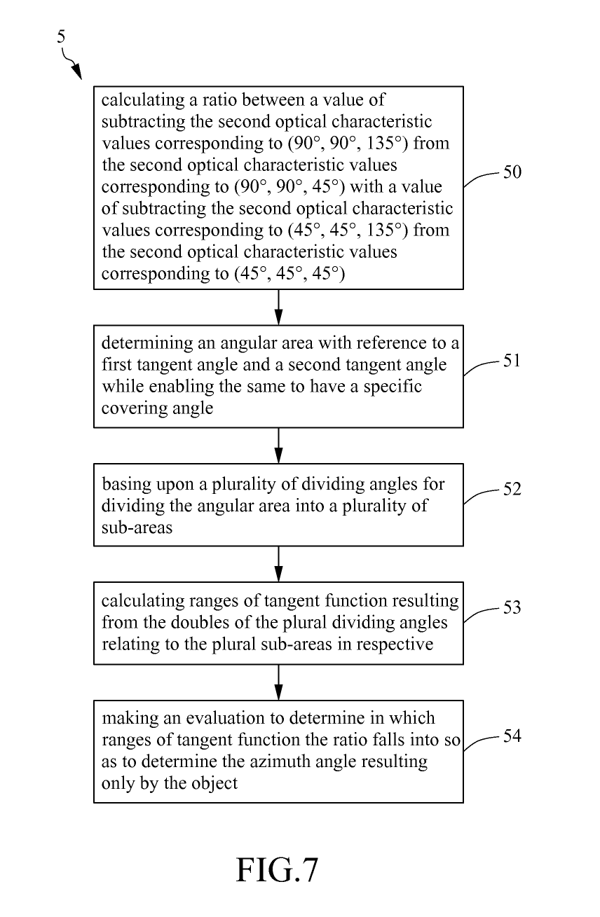

Please refer to FIG. 6, which is a profile of an arctangent function. It is noted that when the azimuth angle obtained using the equation (2) is 45 degrees or 135 degrees, an indefinite result will be caused according to the characteristic of arctangent function, as the area 90 shown in FIG. 6. For overcoming the aforesaid indefinite result, the aforesaid azimuth angle calculation is required to be process further by a procedure provided hereinafter, as shown in FIG. 7. Please refer to FIG. 7, which is a flow chart depicting steps for processing arctangent function according to the present disclosure. The procedure 5 of FIG. 7 starts from step 50. At step 50, a process is performed for calculating a ratio between a value of subtracting the second optical characteristic values corresponding to (90°, 90°, 135°) from the second optical characteristic values corresponding to (90°, 90°, 45°) with a value of subtracting the second optical characteristic values corresponding to (45°, 45°, 135°) from the second optical characteristic values corresponding to (45°, 45°, 45°); and then the flow proceeds to step 51. At step 51, an evaluation is made for determining an angular area with reference to a first tangent angle and a second tangent angle while enabling the same to have a specific covering angle; and then the flow proceeds to step 52. It is noted that, in this embodiment, the specific covering angle is 45 degrees, and the first tangent and the second tangent angle are respectively being the boundaries of this angular area, which are 44 degrees and 46 degree in respective, but are not limited thereby.

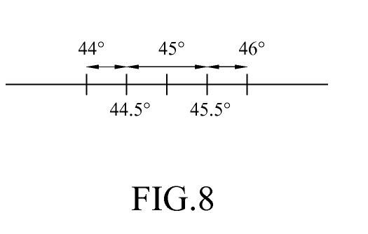

At step 52, basing upon a plurality of dividing angles, the angular area is divided into a plurality of sub-areas, and then the flow proceeds to step 53. In this embodiment, there are four sub-areas, but is not limited thereby and can be divided into any number of sub-areas as required. As shown in FIG. 8, the angles dividing the four sub-areas are 4425 degrees, 45 degrees, and 45.5 degrees that the coverage of each sub-area is 0.5 degree, but is not limited thereby. At step 53, a process is performed for calculating ranges of tangent function resulting from the doubles of the plural dividing angles relating to the plural sub-areas in respective; and then the flow proceeds to step 54. It is noted that the step 53 is performed as following: doubling each dividing angle relating to the boundary of each sub-area, i.e. doubling the value of 44 degrees, 44.5 degrees, 45.5 degrees, and 46 degrees in this embodiment; and then calculating the tangent functions relating to those doubled angle values. After obtaining those tangent functions, the step 54 can be proceeded. At step 54, a process is performed for making an evaluation to determine in which ranges of tangent function the ratio falls into so as to determine the azimuth angle resulting only by the object.

In this embodiment, at the condition when the ratio, i.e.

$$\frac{{I}_{5} - {I}_{3}}{{I}_{4} - {I}_{6}} ,$$

is not smaller than the tangent function resulting from the double of a first tangent angle (44 degrees) and is smaller than the tangent function resulting from the double of a second tangent angle (44.5 degrees) while both the first and the second tangent angles are ranged between 0 degree and 45 degrees as the second tangent angle is larger than the first tangent angle, the azimuth angle resulting only by the object is defined to be the first tangent angle, i.e. 44 degrees; and at the condition when the ratio either is not smaller than the tangent function resulting from the double of the second tangent angle (44.5 degrees), or is smaller than the tangent function resulting from the double of a third tangent angle (45.5 degrees), while the third tangent angle is ranged between 45 degrees and 90 degrees, the azimuth angle resulting only by the object id defined to be an angle ranged between the second tangent angle and the third tangent angle, in that the present embodiment select 45 degrees as the azimuth angle resulting only by the object; and moreover, at the condition when the ratio is either not smaller than the tangent function resulting from the double of the third tangent angle (45.5 degrees), or is smaller than the tangent function resulting from the double of a fourth tangent angle (46 degrees), while the fourth tangent angle is ranged between 45 degrees and 90 degrees as the fourth tangent angle is larger than the third tangent angle, the azimuth angle resulting only by the object is defined to be the fourth tangent angle, i.e. 46 degrees.

The aforesaid embodiment is adapted for describing the condition when the raw azimuth angle is 45 degrees. However, the procedure can also be adapted for the condition when the raw azimuth angle is 135 degrees, by that the angular range will be between 134 degrees and 136 degrees while the angles relating to its three relating boundaries are 134.5 degrees, 135 degrees and 135.5 degrees. Accordingly, at the condition when the ratio, i.e.

$$\frac{{I}_{5} - {I}_{3}}{{I}_{4} - {I}_{6}} ,$$

is not smaller than the tangent function resulting from the double of a first tangent angle (134 degrees) and is smaller than the tangent function resulting from the double of a second tangent angle (134.5 degrees) while both the first and the second tangent angles are ranged between 0 degree and 135 degrees as the second tangent angle is larger than the first tangent angle, the azimuth angle resulting only by the object is defined to be the first tangent angle, i.e. 134 degrees; and at the condition when the ratio either is not smaller than the tangent function resulting from the double of the second tangent angle (134.5 degrees), or is smaller than the tangent function resulting from the double of a third tangent angle (1355.5 degrees), while the third tangent angle is ranged between 135 degrees and 180 degrees, the azimuth angle resulting only by the object id defined to be an angle ranged between the second tangent angle and the third tangent angle, in that the present embodiment select 135 degrees as the azimuth angle resulting only by the object; and moreover, at the condition when the ratio is either not smaller than the tangent function resulting from the double of the third tangent angle (135.5 degrees), or is smaller than the tangent function resulting from the double of a fourth tangent angle (136 degrees), while the fourth tangent angle is ranged between 135 degrees and 180 degrees as the fourth tangent angle is larger than the third tangent angle, the azimuth angle resulting only by the object is defined to be the fourth tangent angle, i.e. 136 degrees.

Basing upon the aforesaid equation (1) and equation (2), it is noted that the accurate retardance as well as the azimuth angle resulting only by the object can be obtained through the use of the corresponding correction procedures. Although the aforesaid embodiments are performed according to the previously obtained six images of background retardance without the tested object and six images influenced by the presence of the tested object, it is known to those skilled in the art that: by selecting only a portion of the groups in the grouping consisting of: (45°, 45°, 90°), (45°, 45°, 0°), (45°, 45°, 45°), (45°, 45°, 135°), (90°, 90°, 45°), and (90°, 90°, 135°) for obtaining corresponding optical characteristic values to be used in the calculation, the property of the object can also be obtained. The following description relates to the use of four images of background retardance without the tested object, i.e. B₁˜B₄, and six images influenced by the presence of the tested object, i.e. I₁˜I₄, for obtained the property of the object, whereas the configuration of the optical measurement system for obtaining the aforesaid images are defined according to the following Table 3.

| grouping | First retarder | Second retarder | analyzer |
|---|---|---|---|
| 1 | 45° | 45° | 90° |
| 2 | 45° | 45° | 0° |
| 3 | 90° | 90° | 135° |
| 4 | 45° | 45° | 45° |

Thereby, the calculation is performed using the following equations:

$$\begin{matrix}\frac{( {I}_{1} + {I}_{2} )}{2} = {I}_{b} & ( 3 ) \\ δ = {tan}^{- 1} [ \sqrt{{( \frac{{I}_{3} - {I}_{b}}{{I}_{2} - {I}_{b}} - \frac{{B}_{3} - {B}_{b}}{{B}_{3} - {B}_{b}} )}^{2} + {( \frac{{I}_{4} - {I}_{b}}{{I}_{1} - {I}_{b}} - \frac{{B}_{4} - {B}_{b}}{{B}_{1} - {B}_{b}} )}^{2}} ] & ( 4 ) \\ φ = \frac{1}{2} {tan}^{- 1} [ \frac{\frac{{I}_{3} - {I}_{b}}{{I}_{2} - {I}_{b}} - \frac{{B}_{3} - {B}_{b}}{{B}_{3} - {B}_{b}}}{\frac{{I}_{4} - {I}_{b}}{{I}_{1} - {I}_{b}} - \frac{{B}_{4} - {B}_{b}}{{B}_{1} - {B}_{b}}} ] & ( 5 )\end{matrix}$$

wherein, δ is the raw retardance;
φ is the raw azimuth angle;
B₁˜B₄ are the intensities of the six images of background retardance that are taken according to Table 3;
I₁˜I₄ are the intensities of the four images influenced by the presence of the tested object, that are taken according to Table 3.
   It is noted that the raw retardance 8 and the raw azimuth angle φ obtained by the equations (4) and (5) can be corrected by correction procedures similar to those disclosed in the aforesaid embodiments, and thus are not described further herein.

Moreover, by configuring the optical measurement system according to the following Table 4, the equations for calculating the retardance δ and azimuth angle φ are defined as following:

$$\begin{matrix}\frac{( {I}_{1} + {I}_{2} )}{2} = {I}_{b} & ( 6 ) \\ δ = {tan}^{- 1} [ 2 ( {I}_{4} - {I}_{5} ) / ( {I}_{1} - {I}_{2} ) ( cos 2 θ - sin 2 θ ) ] & ( 7 ) \\ φ = \frac{1}{2} {tan}^{- 1} [ \frac{{I}_{5} - {I}_{b}}{{I}_{4} - {I}_{b}} ] & ( 8 )\end{matrix}$$

| grouping | First retarder | Second retarder | analyzer |
|---|---|---|---|
| 1 | 45° | 45° | 90° |
| 2 | 45° | 45° | 0° |
| 3 | 90° | 90° | 45° |
| 4 | 45° | 45° | 45° |

It is noted that the raw retardance δ and the raw azimuth angle φ obtained by the equations (7) and (8) can be corrected by correction procedures similar to those disclosed in the aforesaid embodiments, and thus are not described further herein. Moreover, according to the angular configuration selections disclosed in Table 1, Table 3 and Table 4, those skilled in the art can concluded that there can be various angular configurations capable of being applied in the method of the present disclosure to be used for obtaining the accurate retardance and azimuth angle resulting only by the object.

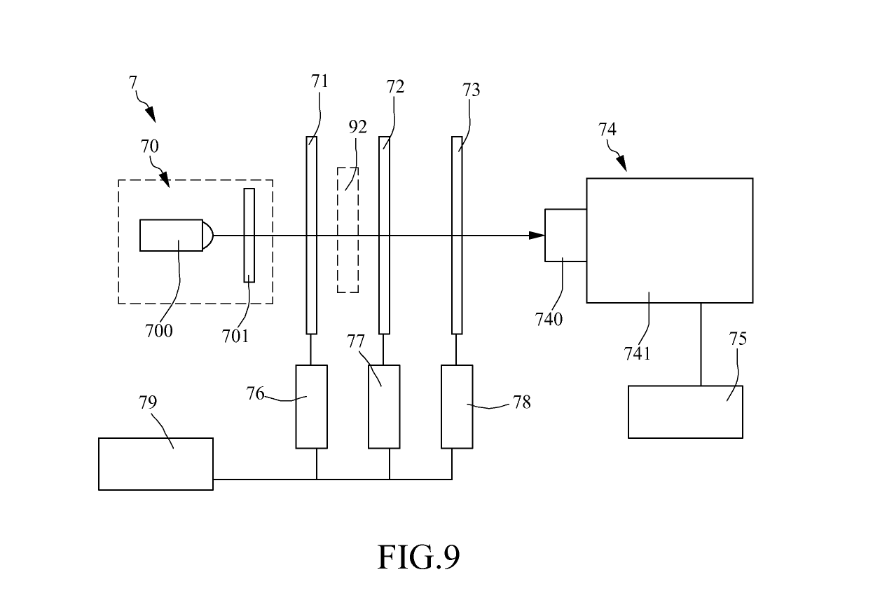

Please refer to FIG. 9, which is a schematic diagram showing an object characteristic measurement system according to another embodiment of the present disclosure. The object characteristic measurement system 7 of FIG. 7 comprises: a linear polarization module 70, a first retarder 71, a second retarder 72, a linear analyzer 73, an imaging unit 74 and a calculation unit 75. In this embodiment, the linear polarization module 70, being used for providing a linear polarized light, is composed of a light source 700 and a linear polarizer 701. It is noted that the light source 700 is not only can be configured for emitting a collimated light of single wavelength as the one shown in this embodiment, but also can be configured for emitting a collimated light of multiple wavelengths in another embodiment. But for the embodiment using light source for emitting a collimated light of multiple wavelengths, it is required to have a beam splitter being disposed in front of the imaging unit 74 that enables the imaging unit 74 to receive only a collimated light of single wavelength similar to the one shown in FIG. 9. Moreover, the linear polarizer 701 is provided for polarizing the collimated light into the linear polarized light. As for the first retarder 71 and the second retarder 72, they are both being disposed at a side of the linear polarization module 70 for receiving the linear polarized light, whereas the two are configured in a manner that the first retarder 71 is arranged between the second retarder 72 and the liner polarization module 70 while forming a space between the first retarder 71 and the second retarder 72 to be used for receiving an object 92.

In addition, the first retarder 71 and the second retard 72 can be driven to rotate in a synchronized manner by a first driving force. In this embodiment, the first retarder 71 and the second retarder 72 are coupled respectively to two driving units 76, 77 that used for providing the first driving forces respectively to the first retarder 71 and the second retarder 72 for driving the two to rotate in synchronization, whereas the two driving units can be motors, but are not limited thereby. Similarly, the linear analyzer 73 is also coupled to a driving unit 78 that is also used for providing a driving force to the linear analyzer 73 for driving the same to rotate. As shown in FIG. 9, each of the three driving units 76, 77, 78 is connected to a control unit 79, which is provided for issuing control signals to control the rotations of the three components driven respectively by the three driving units 76, 77, 78. Since the aforesaid driving means for enabling the first retarder 71, the second retarder 72 and the linear analyzer 73 to rotate are known technique to those skilled in the art, thus, it is not described further herein.

As shown in FIG. 9, the imaging unit 74 is used for capturing an image of intensity resulting from the linear polarized light after it had sequentially traveled passing the first retarder 71, the second retarder 72, and the linear analyzer 73. In this embodiment, the imaging unit 74 further comprises: a display element 740; and an image capturing element 741 such as a CCD or a CMOS. Moreover, the calculation unit 75 is coupled to the imaging unit 74 so as to execute the steps depicted in the flow charts shown in FIG. 2, FIG. 4, FIG. 5 and FIG. 7. That is, in response to the multiple images form the imaging unit that are captured with reference to the multiple angular configurations of the first retarder, the second retarder and the linear analyzer, the calculation unit is able to perform a calculation process for obtaining the material property of the object. Moreover, by selecting only a portion of the groups in the grouping consisting of: (45°, 45°, 90°), (45°, 45°, 0°), (45°, 45°, 45°), (45°, 45°, 135°), (90°, 90°, 45°), and (90°, 90°, 135°) for obtaining corresponding optical characteristic values to be used in the calculation, the calculation unit is able to obtained the material property of the object. In another embodiment, the control unit 79 can be integrated with the calculation unit 75 into a single unitary unit.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An object characteristic measurement method, comprising the steps of:
providing a polarized light while enabling the same to pass sequentially through a first retarder, a second retarder and an analyzer;
enabling the fast axis of the first retarder and the slow axis of the second retarder to turn in synchronization to a first angle and a second angle so as to respectively capture a plurality of first optical characteristic values relating to the analyzer at different polarization angles in correspondence to the first and the second angle;
enabling the fast axis of the first retarder and the slow axis of the second retarder to turn in synchronization to the first angle and the second angle so as to respectively capture a plurality of second optical characteristic values relating to the analyzer at different polarization angles in correspondence to the first and the second angle; and
performing a calculation for obtaining a property of an object according to the first optical characteristic values and the second optical characteristic values as the object is disposed at a position between the first retarder and the second retarder.

2. The method of claim 1, wherein the property of the object is a value of retardance.

3. The method of claim 2, wherein the grouping of the values of the first angle, the second angle and the polarization angle of the analyzer are selected from the group consisting of: (45°, 45°, 90°), (45°, 45°, 0°), (45°, 45°, 45°), (45°, 45°, 135°), (90°, 90°, 45°), and (90°, 90°, 135°).

4. The method of claim 3, further comprising the step of:
selecting a portion of the groups in the grouping consisting of: (45°, 45°, 90°), (45°, 45°, 0°), (45°, 45°, 45°), (45°, 45°, 135°), (90°, 90°, 45°), and (90°, 90°, 135°) for obtaining corresponding optical characteristic values to be used in the calculation for obtaining the property of the object.

5. The method of claim 2, wherein the grouping of the values of the first angle, the second angle and the polarization angle of the analyzer are selected from the group consisting of (45°, 45°, 90°), (45°, 45°, 0°), (45°, 45°, 45°), (90°, 90°, 135°), or form another group consisting of: (45°, 45°, 90°), (45°, 45°, 0°), (90°, 90°, 45°), and (45°, 45°, 45°).

6. The method of claim 2, the calculation includes a retardance correction procedure for achieving the retardance resulting only by the object, the retardance correction procedure comprising the steps of:
subtracting the second optical characteristic values corresponding to (45°, 45°, 0°) from the second optical characteristic values corresponding to (45°, 45°, 90°);
enabling the obtained retardance from the calculation to be the retardance resulting only by the object if the subtraction is not smaller than zero; and
enabling the retardance resulting only by the object to be the value equal to the subtracting of the obtained retardance of the calculation from 180 degrees if the subtraction is smaller than zero.

7. The method of claim 1, wherein the property of the object is a value of azimuth angle.

8. The method of claim 7, wherein the calculation includes an azimuth angle correction procedure for achieving the azimuth angle resulting only by the object, the azimuth angle correction procedure comprising the steps of:
subtracting the second optical characteristic values corresponding to (45°, 45°, 0°) from the second optical characteristic values corresponding to (45°, 45°, 90°);
enabling the obtained azimuth angle from the calculation to be the azimuth angle resulting only by the object if the subtraction is not smaller than zero and the obtained azimuth angle is larger than zero, otherwise, enabling the azimuth angle resulting only by the object to be the obtained azimuth angle plus 90 degrees if the subtraction is not smaller than zero but the obtained azimuth angle is smaller than zero; and
enabling the azimuth angle resulting only by the object to be the obtained azimuth angle plus 90 degrees if the subtraction is smaller than zero and the obtained azimuth angle is larger than zero, otherwise, enabling the azimuth angle resulting only by the object to be the obtained azimuth angle plus 180 degrees if the subtraction is smaller than zero and the obtained azimuth angle is smaller than zero.

9. The method of claim 7, wherein the calculation includes an azimuth angle correction procedure for achieving the azimuth angle resulting only by the object, the azimuth angle correction procedure comprising the steps of:
calculating a ratio between a value of subtracting the second optical characteristic values corresponding to (90°, 90°, 135°) from the second optical characteristic values corresponding to (90°, 90°, 45°) with a value of subtracting the second optical characteristic values corresponding to (45°, 45°, 135°) from the second optical characteristic values corresponding to (45°, 45°, 45°);
determining an angular area with reference to a first tangent angle and a second tangent angle while enabling the same to have a covering angle of 45 degrees;
basing upon a plurality of dividing angles for dividing the angular area into a plurality of sub-areas;
calculating ranges of tangent function resulting from the doubles of the plural dividing angles in respective; and
making an evaluation to determine in which ranges of tangent function the ratio falls into so as to determine the azimuth angle resulting only by the object.

10. The method of claim 7, wherein the calculation includes an azimuth angle correction procedure for achieving the azimuth angle resulting only by the object, the azimuth angle correction procedure comprising the steps of:
calculating a ratio between a value of subtracting the second optical characteristic values corresponding to (90°, 90°, 135°) from the second optical characteristic values corresponding to (90°, 90°, 45°) with a value of subtracting the second optical characteristic values corresponding to (45°, 45°, 135°) from the second optical characteristic values corresponding to (45°, 45°, 45°);
determining an angular area with reference to a first tangent angle and a second tangent angle while enabling the same to have a covering angle of 135 degrees;
basing upon a plurality of dividing angles for dividing the angular area into a plurality of sub-areas;
calculating ranges of tangent function resulting from the doubles of the plural dividing angles relating to the plural sub-areas in respective; and
making an evaluation to determine in which ranges of tangent function the ratio falls into so as to determine the azimuth angle resulting only by the object.

11. The method of claim 7, wherein the calculation includes an azimuth angle correction procedure for achieving the azimuth angle resulting only by the object, the azimuth angle correction procedure comprising the steps of:
calculating a ratio between a value of subtracting the second optical characteristic values corresponding to (90°, 90°, 135°) from the second optical characteristic values corresponding to (90°, 90°, 45°) with a value of subtracting the second optical characteristic values corresponding to (45°, 45°, 135°) from the second optical characteristic values corresponding to (45°, 45°, 45°);
if the ratio is not smaller than the tangent function resulting from the double of a first tangent angle and is smaller than the tangent function resulting from the double of a second tangent angle while both the first and the second tangent angles are ranged between 0 degree and 45 degrees as the second tangent angle is larger than the first tangent angle, enabling the azimuth angle resulting only by the object to be the first tangent angle;
if the ratio either is not smaller than the tangent function resulting from the double of the second tangent angle, or is smaller than the tangent function resulting from the double of a third tangent angle, while the third tangent angle is ranged between 45 degrees and 90 degrees, enabling the azimuth angle resulting only by the object to be an angle ranged between the second tangent angle and the third tangent angle; and
if the ratio either is not smaller than the tangent function resulting from the double of the third tangent angle, or is smaller than the tangent function resulting from the double of a fourth tangent angle, while the fourth tangent angle is ranged between 45 degrees and 90 degrees as the fourth tangent angle is larger than the third tangent angle, enabling the azimuth angle resulting only by the object to be the fourth tangent angle.

12. The method of claim 7, wherein the calculation includes an azimuth angle correction procedure for achieving the azimuth angle resulting only by the object, the azimuth angle correction procedure comprising the steps of:
calculating a ratio between a value of subtracting the second optical characteristic values corresponding to (90°, 90°, 135°) from the second optical characteristic values corresponding to (90°, 90°, 45°) with a value of subtracting the second optical characteristic values corresponding to (45°, 45°, 135°) from the second optical characteristic values corresponding to (45°, 45°, 45°);
if the ratio either is not smaller than the tangent function resulting from the double of a fifth tangent angle, or is smaller than the tangent function resulting from the double of a sixth tangent angle, while both the fifth and the sixth tangent angles are ranged between 90 degrees and 135 degrees as the sixth tangent angle is larger than the fifth tangent angle, enabling the azimuth angle resulting only by the object to be the fifth tangent angle;
if the ratio either is not smaller than the tangent function resulting from the double of the sixth tangent angle, or is smaller than the tangent function resulting from the double of a seventh tangent angle, while the seventh tangent angle is ranged between 135 degrees and 180 degrees, enabling the azimuth angle resulting only by the object to be an angle ranged between the sixth tangent angle and the seventh tangent angle; and
if the ratio either is not smaller than the tangent function resulting from the double of the seventh tangent angle, or is smaller than the tangent function resulting from the double of an eighth tangent angle, while the eighth tangent angle is ranged between 135 degrees and 180 degrees as the eighth tangent angle is larger than the seventh tangent angle, enabling the azimuth angle resulting only by the object to be the eighth tangent angle.

13. The method of claim 1, wherein the property of the object is a grouping consisting of: a value of retardance and a value of azimuth angle.

14. The method of claim 1, wherein the first angle and the second angle are specified respectively to be 45 degrees and 90 degrees.

15. The method of claim 14, wherein the different polarization angles of the analyzer includes: 0 degree, 45 degrees, 90 degrees and 135 degrees.

16. The method of claim 14, wherein each of the first optical characteristic values and the second optical characteristic values is a value of light intensity.

17. An object characteristic measurement system, comprising:
a linear polarization module, for providing a linear polarized light;
a retarding element, including a first retarder and a second retarding, both being disposed at a side of the liner polarization module for receiving the linear polarized light while capable of being respectively driving to rotate in synchronization by a first driving force, being configured in a manner that the first retarder is arranged between the second retarder and the liner polarization module while forming a space between the first retarder and the second retarder to be used for receiving an object;
a linear analyzer, disposed at a side of the second retarder while capable of being driven to rotate by a second driving force;
an imaging unit, for capturing an image of intensity resulting from the linear polarized light after it had sequentially traveled passing the first retarder, the second retarder, the object, and the linear analyzer; and
a calculation unit, for performing a calculation for obtaining a property of the object, basing upon the following data sets: a plurality of angular arrangements relating to the angles of the first retarder, the second retarder and the linear analyzer in combination, images obtained from the imaging unit that are captured while the object is not existed in the space, and images obtained from the imaging unit that are captured while the object is existed in the space.

18. The system of claim 17, wherein the property of the object is related to a value selected from the group consisting of: a value of retardance, a value of azimuth angle, and the combination thereof.

19. The system of claim 17, wherein the grouping of the values of the first angle, the second angle and the polarization angle of the analyzer are selected from the group consisting of: (45°, 45°, 90°), (45°, 45°, 0°), (45°, 45°, 45°), (45°, 45°, 135°), (90°, 90°, 45°), and (90°, 90°, 135°).

20. The system of claim 19, wherein the calculation unit is enabled to select a portion of the groups in the grouping consisting of: (45°, 45°, 90°), (45°, 45°, 0°), (45°, 45°, 45°), (45°, 45°, 135°), (90°, 90°, 45°), and (90°, 90°, 135°) for obtaining corresponding optical characteristic values to be used in the calculation for obtaining the property of the object.

21. The system of claim 17, wherein the grouping of the values of the first angle, the second angle and the polarization angle of the analyzer are selected from the group consisting of: (45°, 45°, 90°), (45°, 45°, 0°), (45°, 45°, 45°), (90°, 90°, 135°), or form another group consisting of: (45°, 45°, 90°), (45°, 45°, 0°), (90°, 90°, 45°), and (45°, 45°, 45°).

22. The system of claim 17, wherein the linear polarization module further comprises a light source and a linear polarizer.

23. The system of claim 17, wherein the imaging unit further comprises: a display element and an image capturing element.
